(19) United States
(12) Patent Application Publication
(10) Pub. No.: US 2006/0142902 A1
(43) Pub. Date: Jun. 29, 2006

(54) Method for the informative assistance of a vehicle driver by means of an on-board multimedia system

(75) Inventors: Stefan Hohl, Stuttgart (DE); Markus Melheritz, Ditzingen (DE); Uwe Thoms, Stuttgart (DE); Marcus Windhab, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/538,660

(22) PCT Filed: Nov. 8, 2003
(86) PCT No.: PCT/EP03/12486

§ 371 Date: Dec. 1, 2005

(30) Foreign Application Priority Data
Dec. 11, 2002 (DE) 102 57 788.9

(51) Int. Cl. G06F 7/00

(52) U.S. Cl. 701/1; 701/36

(57) ABSTRACT

This invention relates to a method for informative support of a driver of a vehicle by means of a vehicle multimedia system, comprising a vehicle computer and an external computer, whereby the vehicle computer and the external computer exchange data over a bidirectional communication at least occasionally. According to this invention special memory areas are provided in the vehicle computer and in the external computer, whereby the contents of the memory areas characterize elements of an information supply available to and selectable by the driver of the vehicle by means of the vehicle multimedia system whereby the contents of these special memory areas are modifiable by the driver of the vehicle by an input mode which does not negatively affect driving safety and whereby the contents of the special memory areas are automatically compared.

This application claims the priority of German patent document 102 57 788.9 filed Dec. 11, 2002 (PCT International Application PCT/EP/2003/012486, filed Nov. 8, 2003 and published as WO 2004/053811 A1), the disclosure of which is expressly incorporated by reference herein.

This invention relates to a method for providing information to support a vehicle driver, using a vehicle multimedia system. Such a vehicle multimedia system offers the driver information and accounting options (e.g., access to address management, trip navigation and Internet access).

Multimedia systems are increasingly common in modern vehicles. However, while today's users are generally accustomed to using multimedia systems, with the constantly growing flood of information, the selection of information that is actually of interest for the user is becoming increasingly complex. Another problem with a vehicle is that use of such systems is limited for ergonomic reasons, because operational safe must always have priority.

In European Patent Document EP 1 143 679 A2 a multimedia system has an external computer that adapts requested data individually to a requesting computer, with a multitude of types of presentation of data being provided. No special support for the driver of the vehicle is provided.

German Patent Document DE 200 16 746 U1 discloses a multimedia system in which an external computer dynamically links data from various databases, and supplies it to a requesting computer for retrieval. No special support is provided for the driver of a vehicle in this case either.

International patent document WO 01 22712 A1 discloses a method for remote configuration of a multimedia device. Spontaneous information requests by the driver of a vehicle while driving cannot be processed with this system.

German Patent Document DE 100 24 007 A1, which defines the genre of the present invention, presents a vehicle multimedia system in which destination data for trip navigation is edited on the user's home computer, transferred to an external computer and transmitted by wireless transfer from the external computer to the vehicle. Spontaneous information requests by the driver of a vehicle while driving cannot be processed here, either.

One object of the present invention is to provide a method for providing information support to a vehicle driver which will allow a change and request of information at any time while driving, inexpensively, conveniently and rapidly while at the same time ensuring safe driving of the vehicle.

This and other objects and advantages are achieved by the method according to the invention, in which special memory areas are provided in the vehicle computer and in the external computer. The contents of these memory areas characterize elements of a supply of information that is available to and selectable by the driver by means of the vehicle media system. The contents of these special memory areas can be altered by the driver of the vehicle through an input mode that does not have a negative effect on driving safety, and such contents are automatically compared in the vehicle computer and in the external computer. In other words, the vehicle multimedia system has a variable vehicle-dependent information supply, which is known in both the vehicle computer and in the external computer. Information supply in this instance does not mean that the corresponding information is already in the vehicle computer and/or in the external computer. Rather, information supply means an “index” of a limited quantity of information that can be accessed by the driver of the vehicle. Access to information is then accomplished by selecting the proper element.

This method has several advantages. For example, the driver of the vehicle is informed at any time rapidly, directly and in a cost-neutral manner regarding such an available information supply, without first having to establish a billable and time-consuming connection to an external computer. In addition, this method ensures in a particularly simple manner a connection to and use of systems already present in the vehicle, and also provides such systems with an information supply available in this way and likewise accessible. By permitting changes in an input mode the method according to the invention ensures a particularly convenient operation which supports driving without any negative effect on safety. Thus an information supply that is tailored to the wishes of the driver is made available to the driver of the vehicle in an ideal manner, and the driver can change this information easily at any time. Furthermore, the fact that previous changes can be documented (and thus can be retrieved again due to the fact that an available information supply is stored in the vehicle computer and in the external computer) has a cost-saving effect; monitoring of an information supply that is already on hand makes it easy to detect unnecessary processes, and multiple changes in an information supply can be collected and transmitted from the external computer to the vehicle computer.

A voice input mode allows the driver to change the contents of the special memory areas in a manner that does not impair driving safety. In addition, or alternatively, manual operation can be provided.

Advantageously, voice input by the driver of the vehicle for altering the contents of the special memory areas is processed by the external computer. This permits particularly rapid and thorough processing of the voice input, because the external computer has a much greater computation capacity, and also has additional means in comparison with the vehicle computer. Voice input by the driver of the vehicle to the external computer can therefore be transformed, e.g., in voice form (“telephony”) or in data form.

It is particularly advantageous if the processing by the external computer is performed by a human operator, who can check the information content of an element in a targeted manner before it is added to an information supply that is made available to the driver of the vehicle via the vehicle multimedia system. For example, the human operator may select a single element from an automatically generated list of possibilities. In ambiguous cases, the human operator may also act in a supportive and advising capacity. In simple manner, this minimizes the extent the driver's involvement in providing an element of the information supply, thereby ensuring convenience and traffic safety.

Another input mode for altering the contents of the special memory areas in a manner that does not interfere with driving safety is to have the change performed by the front-seat passenger and/or by a passenger in the rear. Therefore this invention can also be used in a particularly flexible manner. The changes may be performed, for example, even according to specifications by the driver of the vehicle. The changes are performed by the front-seat passenger and/or the rear passengers, e.g., by voice input and/or manual operation.

In an advantageous embodiment of the invention, the contents of the special memory areas (i.e., the vehicle computer and external computer) are compared according to various criteria, so that different parts of the contents of the special memory areas may also be compared according to different criteria. Such comparison can be performed automatically after triggering by the driver (e.g., by triggering of an operating element), or it may be event-controlled (e.g., upon starting the vehicle, or when activating the communication device in the vehicle), time-controlled or controlled by the external computer. Of course any combination of these options may also be provided. In determining a criterion (for example, the importance), the cost generated and/or the urgency of an element of the information supplied are to be taken into account; these criteria may also be determined by the driver of the vehicle.

In a further advantageous embodiment, an element to be removed from the information supply of the vehicle multimedia system is not deleted from the special memory areas but instead is provided with a special identifier, which makes it unavailable to the vehicle multimedia system. This feature of the invention has the advantage that elements of the information supply, having once been made available via the vehicle multimedia system, can be “reactivated” in a manner that minimizes cost, time and effort, by merely deleting the special identifier, and making the information available again for the vehicle multimedia system.

Convenience and traffic safety are further enhanced if an element is selected from the available information supply by voice input from the driver. Since this involves only a relatively small extent of voice commands, it is possible to provide for the voice input to be processed by the vehicle computer. Alternatively or additionally (e.g., in the case of voice input that is difficult to understand), processing on the external computer may be provided.

According to yet another advantageous embodiment of the invention, a navigation unit is provided as part of the vehicle computer. Geographic positions pertaining to an element of the information supply that is available to the driver of the vehicle via the vehicle multimedia system are converted with their first use by the navigation unit into navigation-unit-specific coordinates; the latter are stored in such a way that they are associated with the element. In this way, the complex conversion of the geographic coordinates of the origin is performed by the vehicle-specific navigation unit; these original coordinates are provided to the navigation unit after access to the information and are converted into coordinates to be used by the vehicle-specific navigation unit only at the time of the initial access. After such conversion with the initial access, the navigation unit-specific coordinates are stored so that they are also available in the event of renewed selection of the specific element by the driver of the vehicle. To do so, for example, a portion of the special memory area is provided for this purpose. In all subsequent retrievals, the navigation system is triggered directly with the navigation-means-specific coordinates and renewed complex conversion of coordinates is omitted.

The vehicle computer and the external computer advantageously use a wireless network for bidirectional communication. Modern wireless networks offer platforms on which the inventive method can be implemented at reasonable expense using transmission techniques such as GPRS (General Packet Radio Service) or WAP (Wireless Application Protocol).

Advantageously, the vehicle computer can also be used for access to an information supply available outside of the vehicle multimedia system. This information supply may also be personalized, e.g., by an intelligent preselection according to user preferences. This “free” information access (i.e., access that can be performed outside of elements of the information supply available to and selectable by the driver of the vehicle by means of the vehicle multimedia system) eliminates in the individual case access to the external computer when the driver already knows precisely which information he or she would like to access, e.g., a WAP address.

In still another advantageous embodiment, a device is provided for recognizing the driver of a vehicle, a e.g., a chip card or a biometric identification. Thus the vehicle multimedia system makes the information supply available on a personalized basis, e.g., when a vehicle is frequently used by different drivers and/or when a driver frequently uses different vehicles. Other possibilities for personalization includes specific vehicle keys (the driver of the vehicle is identified in the vehicle on the basis of the vehicle key used) or specific calling numbers (the driver of the vehicle is identified on the part of the external computer, e.g., on the basis of the calling number of the cell phone used).

According to another embodiment, to alter the contents of the special memory areas, additional means and/or access possibilities are provided, e.g., a mobile device (PDA, personal digital assistant), thus ensuring universal operability.

This invention is preferably implemented as a computer program having program code means, whereby a respective embodiment of the inventive method is implemented when the respective program is executed on a computer.

Another preferred embodiment of the invention is a computer program product having program code stored on a computer-readable data medium to implement a respective embodiment of the inventive method when the respective program product is executed on a computer.

Other objects, advantages and novel features of the present invention will become apparent from the following detailed description of the invention when considered in conjunction with the accompanying drawings.

### BRIEF DESCRIPTION OF THE DRAWINGS

FIG. 1 is a flow chart of a process for implementing changes in the contents of an information supply available to the driver of the vehicle by means of the vehicle multimedia system (“device”); and

FIG. 2 is a flow chart which shows the selection of elements of an information supply available to the vehicle driver via the vehicle multimedia system together with its vehicle connection (“use”).

### DETAILED DESCRIPTION OF THE DRAWINGS

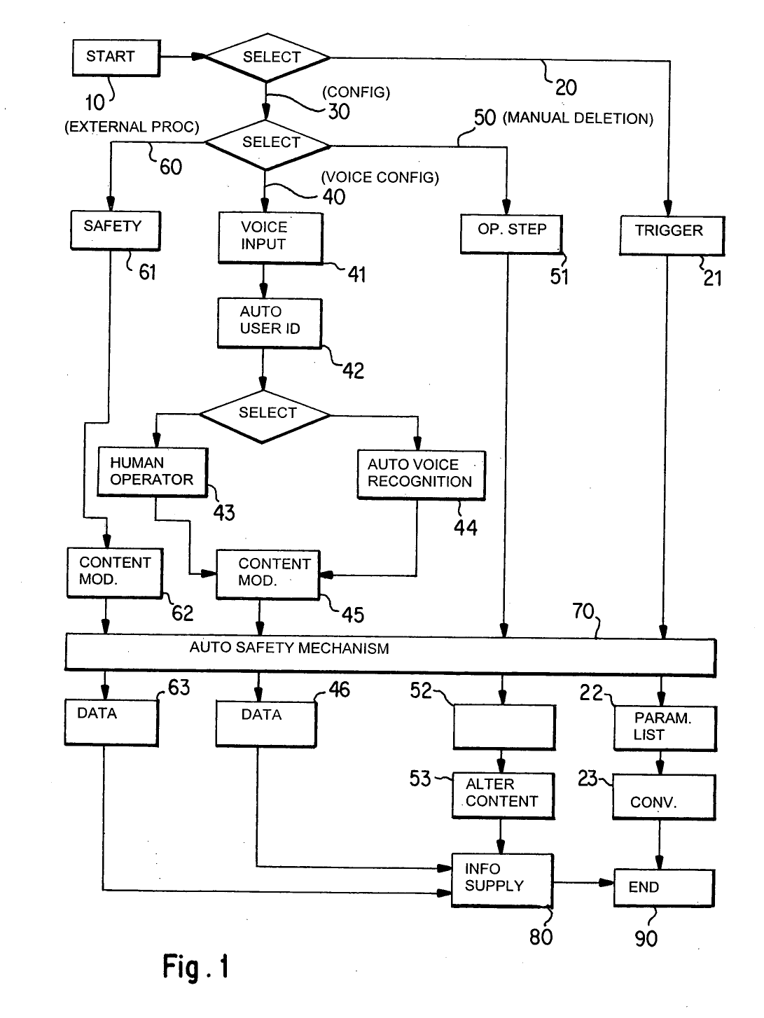

FIG. 1 illustrates the sequences according to the invention, for changing the contents of an information supply that is available to the vehicle driver via the vehicle multimedia system. The start 10 is followed by an authorization 20, a configuration 30, a voice-controlled configuration 40, a manual element deletion 50 and an external processing 60, with various processing steps being run through. In each case, an automatic safety mechanism 70 is used before data is stored in the vehicle computer and the end of processing 90 is reached. The end of processing 90 includes at least one proper termination of the existing communication link between the vehicle computer and external computer and an assignment of the costs incurred to the driver of the vehicle. The automatic safety mechanism 70 ensures that in no case will unwanted, unsuitable and/or maliciously altered data reach the vehicle. This important step thus reliably ensures access to data by the vehicle, and that the inventive method can in no case lead to a situation that is critical for the safety and/or functioning of the vehicle. To eliminate the possibility of such a critical situation which might occur with so-called hacker attacks, for example, suitable encryption and identification methods are provided with the automatic safety mechanism 70.

The authorization 20 serves to ensure bidirectional communication between the vehicle computer and the external computer. The authorization 20 is not triggered by the driver of the vehicle, nor is he or she involved in its processing. Rather, it is triggered by the external computer and/or by a human operator of the external computer. Such triggering occurs, for example, when there are planned changes in telephone numbers or parameters which are used in bidirectional communication between the vehicle computer and the external computer. As a rule, such changes occur only very rarely. After being triggered 21, the data and parameter list 22 needed to ensure bidirectional communication between the vehicle computer and the external computer is transmitted to the vehicle after running through the automatic safety mechanism 70. In the vehicle, a corresponding data and parameter conversion 23 is then performed on the vehicle multimedia system with this data and parameter list 22.

The configuration 30 combines all possibilities of changes which can be performed by the driver of the vehicle on the elements of an information supply available to the driver of the vehicle by means of the vehicle multimedia system.

The voice-controlled configuration 40 begins with voice input 41 by the driver of the vehicle, which may be followed by automatic user identification 42, if such identification has not already occurred. For example, when using a wireless network for transmission of the voice input to the external computer, this automatic user identification 42 is accomplished by checking the SIM (subscriber identification module, user-specific chip card). After user identification 42, either a human operator 43 or an automatic voice recognition system 44 is used for processing the voice input by the driver of the vehicle. Which of these two possibilities is selected will depend, for example, on the type of change requested by the driver of the vehicle, or on a preselection made by the driver of the vehicle. A switch may of course also be performed during a voice-controlled configuration. The human operator 43 or the automatic voice recognition system 44 triggers an addition, modification or deletion of content 45 in the special memory area in the external computer. Depending on the type of automatic comparison of contents of the special memory area in the external computer with the special memory area in the vehicle computer, the comparison is then performed after running through the automatic safety mechanism 70, i.e., the data is transferred to the vehicle.

The external processing 60 permits addition, modification or deletion of the contents 62 in the special memory area in the external computer directly via a safety mechanism 61. The safety mechanism 61 ensures that only authorized external processing is performed. The external processing may be performed, for example, on a home computer which is connected to the external computer via a communication network (Internet) or via a mobile device (PDA, personal digital assistant) which establishes a radio connection to the external computer via a wireless network. Depending on the form of external processing selected, a suitable safety mechanism 61 is provided in each case. In the case of a home computer, this is accomplished by using a password, for example; in the case of a mobile device it is accomplished, e.g., by checking the SIM (subscriber identification module, user-specific chip card). Again, the comparison is performed depending on the type of selected automatic comparison of the contents of the special memory area in the external computer with the special memory area in the vehicle computer after running through the automatic safety mechanism 70, i.e., the data is transferred to the vehicle.

Different criteria are provided for automatic comparison of the contents of the special memory areas in the vehicle computer and the external computer. For example, only a portion of the contents may be compared (e.g., that portion which corresponds to an element of an information supply available to the driver of the vehicle by means of the vehicle multimedia system). A comparison may be performed after triggering by the driver of the vehicle. The driver of the vehicle performs this triggering autonomously, for example, or the driver is informed in this way by a suitable notice that a change has been made in the special memory area on the external computer, so that only a very small volume of data need be transmitted to the vehicle computer. In addition, a comparison may be performed on an event-controlled basis (e.g., when starting the vehicle or when the demands on the driver are anticipated to be low). Likewise, it is possible to provide for the comparison to be performed in a time-controlled manner (e.g., at certain intervals or at a certain time of day). It is also possible to provide for the comparison to be triggered in a manner controlled by the external computer and/or by its human operator.

This is provided, for example, when certain conditions preselected by the driver of the vehicle occur. When using standardized wireless networks such as GPRS (General Packet Radio Service) or UMTS (Unified Mobile Telephone System), these comparison mechanisms are to be implemented by using techniques provided for in these standards (e.g., using so-called push channels) with a reasonable complexity.

After automatic comparison of contents of the special memory areas in the vehicle computer and the external computer, the data 46, 63 are available in the vehicle computer in the same form as in the external computer. These data characterize elements of an information supply 80 available to the driver of the vehicle by means of the vehicle multimedia system after the data have been input into the vehicle computer.

The manual element deletion 50 makes it possible for the driver of the vehicle to manually delete individual elements from the information supply available to the driver, for example, when he or she already knows exactly which element he or she would like to delete. In this case it is not necessary first to establish a connection to the external computer. Instead, this element is manually deleted in the special memory area of the vehicle computer by an operating step 51, which is triggered, for example, by actuation of an operating element or by voice input. After this step and after a comparison of contents of the special memory areas in the vehicle computer and the external computer as explained above (and after running through the automatic safety mechanism 70), the corresponding data 52 are sent from the vehicle to the external computer, where they cause contents 53 in the special memory area in the external computer to be added, altered or deleted. After this comparison, the data in the special memory areas in the vehicle computer and in the external computer characterize contents of elements of an information supply 80 available to the driver of the vehicle by means of the vehicle multimedia system.

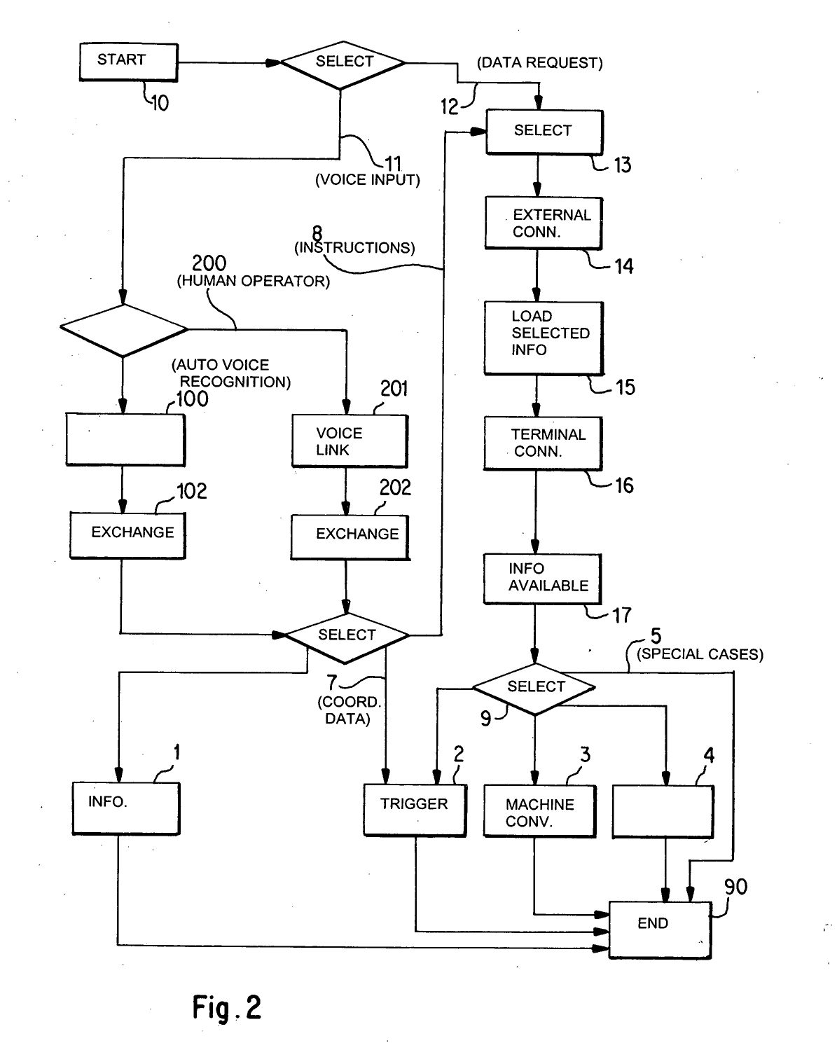

FIG. 2 shows the sequences occurring in the selection of elements of an information supply to be available to the driver of a vehicle by means of the vehicle multimedia system, together with their vehicle connection. The driver of the vehicle makes a selection from the elements, and then the information assigned to an element is made available to the driver of the vehicle and/or other systems via the vehicle connections. The vehicle multimedia system thus uses the bidirectional communication link between the vehicle computer and the external computer. Beginning with the start 10, a voice input 11 and a data request 12 by the driver of the vehicle are provided.

The data request 12 is made by selection 13 of an element of an information supply available to the driver of the vehicle by means of the vehicle multimedia system. For this selection, an input device, such as a touch screen (on which information characterizing an element is displayed and can be selected by the driver of the vehicle touching the screen), a vehicle-supported voice input or a manual operating element are provided. Since the elements of the information supply available to the driver of the vehicle by means of the vehicle multimedia system are stored in the special memory area of the vehicle computer, this step 13 does not require a billable connection to the external computer. Only after making a selection 13 of an element is a connection 14 to the external computer established. Then the information 15 belonging to the selected element is loaded into the vehicle by the external computer. This information 15 need not be available in the external computer, but instead may be requested by it, e.g., from databases or networks (Internet). The word “information” here is to be understood in the broadest sense. For example, it may include text, images, addresses or voice messages. After complete transfer of the information, the connection is terminated 16 between the vehicle computer and the external computer, and the information is made available 17 to the driver of the vehicle.

Making available 17 the information for the driver of the vehicle includes a number of possibilities, some of which are performed in response to explicit requests by the user, while others are also performed automatically. In any case, the driver of the vehicle will be notified, e.g., by acoustic or optical methods, of the fact that the information has been successfully made available to an element of an information supply available to the driver of the vehicle by means of the vehicle multimedia system.

The voice input 11 by the driver of the vehicle is processed either using 200 a human operator or by using 100 an automatic voice recognition system. Which of these two options is selected will depend, for example, on i) the selected element of an information supply that is available to the driver of a vehicle by means of the vehicle multimedia system or ii) a preselection made by the driver of the vehicle. It is of course also possible to switch between the two options during a voice-activated communication link between the vehicle computer and the external computer.

When using a human operator 200, a voice link 201 to this human operator is established. This voice link may be provided, e.g., as a traditional voice connection or as a data connection (voice over IP, voice communication in data format). The human operator may be provided, for example, in the case of the external computer or in a corresponding call center, which is connected to the external computer via a data network, for example. The exchange 202 between the human operator and the driver of the vehicle may consist, for example, of a question-and-answer dialogue, a request for special advice or a direct inquiry for desired information. When using automatic voice recognition 100, an essentially analog sequence is provided. However, the exchange 102 between the automatic voice recognition system and the driver of the vehicle will not permit such complex inquiries and responses as when using a human operator, depending on the voice recognition system used.

Depending on the sequence of the exchange 102 and/or 202, this exchange is followed by different steps. For example, the information 1 provided in the exchange may already be sufficient for the driver of the vehicle, so this is followed by the end of processing 90, which includes at least one proper termination of the existing communication link between the vehicle computer and the external computer, as well as assignment of the costs thereby incurred to the driver of the vehicle.

It is also possible to transfer coordinate data 7 for the navigation device in the vehicle, e.g., following the exchange 102 and/or 202 to the vehicle via the existing communications link. The end of processing 90 follows the triggering 2 of the navigation device with the transmitted coordinate data 7 for navigation using this coordinate data.

In another case, the instruction 8 to select an element of an information supply to be available to the driver of the vehicle via the vehicle multimedia system is given to the driver of the vehicle in the course of the exchange 102 and/or 202. Then the existing communication link between the vehicle computer and the external computer can be used for the subsequent processing steps which were explained above.

The precise details of the bidirectional communication between the vehicle computer and the external computer will not be described further here because those skilled in the art are aware of them. This pertains, for example, to combining different transmissions of information in a single connection process, handling transmission errors and aborted connections and the low-priority handling of the connection process from the vehicle end.

After providing 17 the information for the driver of the vehicle, a selection 9 is made as to how the information thus made available is to be processed further. This selection 9 is made directly by the driver of the vehicle or it is made as an automatic selection, depending on the specifications by the driver of the vehicle, for example, or the type and extent of the information made available.

When coordinate data for the navigation device in the vehicle is part of the information transmitted, with this data the navigation device is triggered 2 and the vehicle is navigated with this coordinate data, e.g., on request by the driver of the vehicle or automatically. If the information includes text elements, machine conversion 3 of these text elements into a synthetic speech output (text to speech) is then provided, depending on the extent of the text elements, for example, or on specifications by the driver of the vehicle. For the case when the information includes image elements such as photographs or graphics, the information may be displayed on display units in the vehicle (e.g., a display screen), again depending on the extent of the image elements or on specifications by the driver of the vehicle, for example. In addition, it is provided that special components of the information may be sent for use by systems already in the vehicle. Examples that can be mentioned here include supplying address data to an address management system assigned to the vehicle computer, transfer of telephone numbers to the telephone number memory of the vehicle telephone and processing of email within the vehicle.

Any combinations are possible here, depending on specifications by the driver of the vehicle and the vehicle equipment, for example. In any case, the end of processing 90 then follows with all the processing operations described before. In special cases 5, in which no other steps are necessary after providing 17 the information, the end of processing 90 is triggered directly. Such a case may be, for example, an autonomous selection of an element by the driver of the vehicle from the information supply available by means of the vehicle multimedia system through the driver of the vehicle; no new information that is of interest for the driver of the vehicle is obtained from this information supply.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for providing information support to a vehicle driver by means of a vehicle multimedia system, which includes a vehicle computer and an external computer that exchange data in a bidirectional communication, said method comprising:
providing special memory areas in the vehicle computer and in the external computer, contents of said special memory areas characterizing elements of information available to and selectable by the driver of a vehicle by means of the vehicle multimedia system;
causing the contents of these special memory areas to be modifiable by the driver of the vehicle through an input mode which does not negatively affect driving safety; wherein, contents of the special memory areas are automatically compared; and
data are exchanged only after successful selection or alteration by the driver of the vehicles via bidirectional communication.

2. The method as claimed in claim 1, wherein the content of the special memory areas can be modified by the driver of the vehicle by one of voice input by and manual operation.

3. The method as claimed in claim 2, the wherein voice input by the driver of the vehicle is processed by the external computer to alter the contents of the special memory areas.

4. The method as claimed in claim 3, the wherein processing is performed at least in part by intervention of a human operator.

5. The method as claimed in claim 4, wherein the contents of the special memory areas are modifiable by a vehicle passenger.

6. The method as claimed in claim 5, wherein the comparison of contents of the special memory areas is performed automatically after one of triggering by the driver, an event-controlled manner, time-controlled manner, and under control of the external computer.

7. The method as claimed in claim 6, wherein an information element designated to be removed from the information supply of the vehicle multimedia system remains in the special memory areas, but is provided with a special identifier which causes this element to be unavailable for the vehicle multimedia system.

8. The method as claimed in claim 7, wherein selection of an element from the information supply available by means of the vehicle multimedia system is performed by the driver of the vehicle, by voice input.

9. The method as claimed in claim 8, wherein a navigation unit autonomous to the vehicle is provided.

10. The method as claimed in claim 9, wherein:
geographic positions which pertain to an element of the information supply available to the driver of the vehicle are converted by the navigation unit into navigation-unit-specific coordinates at the time of their initial use; and,
the coordinates are stored in a manner associated with the element.

11. The method as claimed in claim 10, wherein the vehicle computer and the external computer communicate bidirectionally via a wireless network.

12. The method as claimed in claim 11, wherein the vehicle computer also provides access to an information supply available outside of the vehicle multimedia system.

13. The method as claimed in claim 12, wherein:
means are provided for recognition of a vehicle driver; and
the vehicle multimedia system makes the information supply available on a personalized basis.

14. The method as claimed in claim 13, wherein a driver-specific vehicle key is provided as the means for recognition of a driver of a vehicle.

15. The method as claimed in claim 13, wherein a driver-specific calling number is provided as the means for recognition of a vehicle driver.

16. The method as claimed in claim 15, wherein additional means are provided for altering the contents of the special memory areas.

17. (canceled)

18. A computer program product having program code stored on a computer-readable data medium for performing a method for providing information support to a vehicle driver by means of a vehicle multimedia system which includes a vehicle computer and an external computer that exchange data in a bidirectional communication, said program code including steps for:
providing special memory areas in the vehicle computer and in the external computer, contents of said special memory areas characterizing elements of information available to and selectable by the driver of a vehicle by means of the vehicle multimedia system;
causing the contents of these special memory areas to be modifiable by the driver of the vehicle through an input mode which does not negatively affect driving safety; wherein,
contents of the special memory areas are automatically compared; and
data are exchanged only after successful selection or alteration by the driver of the vehicle via bidirectional communication.
